(19) United States
(12) Patent Application Publication
(10) Pub. No.: US 2007/0084842 A1
(43) Pub. Date: Apr. 19, 2007

(54) Impulse heat sealer

(76) Inventors: Atsunobu Sakamoto, Chiba (JP); Kazuko Sakamoto, Chiba (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/639,345

(22) Filed: Dec. 15, 2006

Related U.S. Application Data
(63) Continuation-in-part of application No. 09/980,659, filed on Apr. 4, 2002.

(30) Foreign Application Priority Data
Jun. 9, 1999 (JP) H11-199410

(51) Int. Cl. B60L 1/02

(52) U.S. Cl. 219/206

(57) ABSTRACT

An impulse heat sealer includes an elongated resistance element attached to a heater circuit and press mechanism. The resistance element includes a zigzag portion formed with a plurality of serpentine portions and slits. The slits have a small width to prevent a gap corresponding to the slits being formed in an elongated seal. The resistance element is elastically pre-stretched and then fixed at both ends to the press mechanism. A protective heat-resistant layer is detachably adhered on the pre-stretched resistance element.

### RELATED APPLICATIONS

This application is a Continuation-In-Part of application Ser. No. 09/980,659 which is §371 of International Patent Application No. PCT/JP00/00035 filed on Jul. 1, 2000. This application claims priority under 35 U.S.C. §119 to Japanese Patent Application No. H11-199410 filed on Jun. 9, 1999. The entire disclosures of each of these applications are incorporated herein by reference in its entirety.

### BACKGROUND OF THE INVENTION

1. Field of the Invention

The present invention relates to an impulse sealer and a book binding machine which thermally melts and fuses material such as polyethylene sheets.

2. Description of Related Art

The following description sets forth the inventors'knowledge of related art and problems therein and should not be construed as an admission of knowledge in the prior art.

An impulse heat sealer causes a current of 8-15 A to flow through a heater having a width of about 2-5 mm, heats the heater to about 150° C. for a short period of time, about one second, and melts and adheres polyethylene and thermally meltable resin. With regard to the heater, a heat generating portion, therefore, uses a narrow-width heat generating portion having a high electrical resistance such as iron chromium and nichrome, and an electrode portion which requires no heat generation and made from, for instance, comparatively thick plated copper plate and iron plate, both being connected, such as by press contacting and spot welding.

As an example of a heater used for an impulse heat sealer, Japanese Laid Open Utility Model Publication S57-167004 (JP '004 UM) discloses metallic resistance element 3 having zigzag shape as shown in FIG. 1. The metallic resistance element 3 generates heat and causes thermal expansion such that the metallic resistance element 3 meanders or partially rises and falls to deform into an undesired shape. This deformed shape causes a problem in that the impulse heat sealer cannot produce a seal in a designed shape. To suppress the motion of the metallic resistance element 3 caused by thermal expansion and prevent its deformation, the metallic resistance element 3 in whole is firmly fixed, by using a bond, on substrate 2 made of epoxy resin material.

However, such configuration of the heater has following problems. Since the impulse heat sealer is required to rapidly heat up and cool down within a few seconds, the metallic resistance element 3 repeats the rapid thermal expansion and shrink. Thus, even if the metallic resistance element 3 is bonded and fixed on the substrate 2, the bond gradually peels off due to the motion of the metallic resistance element 3 caused by thermal expansion such that the metallic resistance element 3 deforms and partially meanders or rises and falls. To prevent this defect, the metallic resistance element 3 may be pre-tensioned to absorb the thermal expansion. However, in FIG. 1, the metallic resistance element 3 may not be pre-tensioned since the metallic resistance element 3 is firmly fixed to the substrate 2. As discussed above, the heater disclosed in JP '044 UM may not be used for practical applications since it is almost impossible to fix the shape of the metallic resistance element 3 during use.

The metallic resistance element 3 has a zigzag shape including gaps. The size of the gap is as large as 0.4 mm. Thus, when the metallic resistance element 3 is heated and pressed against sheet-like material to produce a seal, the produced seal will also contain gaps corresponding to the gaps of the metallic resistance element 3. In other words, the seal has a zigzag shape similar to the metallic resistance element 3, not a ribbon-like shape, and thus the strength of the seal is made lower.

As a method for absorbing the extension of the heater caused by thermal expansion, Japanese Laid Open Utility Model Publication H6-57805 (JP '805 UM) discloses a heat seal device including a ribbon-like resistance element tensioned at one end as shown in FIG. 2. In this device, while one end of the ribbon-like resistance element 3 is fixed, the other end is tensioned by spring member 21. When the ribbon-like resistance element 3 is heated and thermally expands, the tensioned end of the resistance element 3 extends outward and enlarges the total length of the ribbon-like resistance element 3 to prevent the deformation of the heater.

However, such a heat seal device requires an additional mechanism to always tension the end of the resistance element 3. Thus, it results in larger size of the device, increasing cost and cause of trouble.

In addition, the impulse heat sealer clamps, presses and heats two overlapping sheet-like materials and fuses them to each other. During heating process, if the sheet-like material contacts the surface of the heater, the contacted portion of the material would be melted to cake on the heater surface. It is difficult to peel off the coagulated material from the heater surface. To prevent the contact of the sheet-like material, a protective heat-resistant tape such as fluoro resin coated glass tape is provided on the heater surface to intervene between the heater and the sheet-like material. Also, the protective heat-resistant tape needs to be fastened to the heater by any method.

As an example of a method for fastening the protective tape, there is a method in which adhesive is provided on one side of the protective tape to adhere the protective tape to the heater surface by using the adhesive. However, if this method is used with the device as shown in FIG. 2, the difference in the coefficient of thermal expansion between the heater and the protective tape causes a problem that the heater is longitudinally stretched and shrunk to cause shearing stress on the adhesive between the heater and the protective tape such that a crease of the protective tape occurs.

To avoid this problem, as shown in FIG. 3, Japanese Utility Model No. 3,068,890 (JP '890 UM) discloses a method in which protective tape 13 is configured to cover the top surface and both sides of heater 3. Non-adhesive region X is provided, without adhesive, on the protective tape 13 in the area corresponding to the top surface of the heater 3. Adhesive regions Y, Y are provided, with adhesive 131, on the protective tape 13 in the area corresponding to both sides of the heater 3. The protective tape 13 is fastened to the heater 3 by adhering the adhesive regions Y, Y to both sides of the heater 3. Also, as shown in FIG. 4, JP '805 UM discloses a method in which protective tape 13 without adhesive is configured to cover the top surface and both sides of heater 3. Then, the protective tape 13 is clamped by holding cover 14 and fastened to the heater 3.

However, these fastening methods have the following problems: an excessive amount of protective tape 13 is required to cover not only the top surface but both sides of the heater 3; the complicated structure of the protective tape 13 raises cost; and excessive space and cost are required to provide the holding cover 14.

The description herein of advantages and disadvantages of various features, embodiments, methods, and apparatus disclosed in other publications is in no way intended to limit the present invention. For example, certain features of the preferred embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

According to one aspect of a preferred embodiment of the present invention, a impulse heat sealer to seal at least two overlapped sheets comprises:
a. a power source;
b. a heater circuit connected to the power source;
c. a press mechanism to press the overlapped sheets; and
d. a resistance element attached to the heater circuit and the press mechanism, the resistance element comprising:
   i. a heat generating means made of electrically high resistance material to generate heat to seal the overlapped sheets, the heat generating means having an elongated shape and being arranged to produce an elongated seal, the heat generating means having a zigzag portion formed with a plurality of serpentine portions and slits, the slits having a width to prevent a gap corresponding to the slits being formed in the elongated seal by a heat diffusion from the adjacent serpentine portions so that the elongated seal has substantially straight longitudinal sides,
   ii. a pair of electrodes attached at both ends of the heat generating means, each electrode having a width more than twice as large as that of the heat generating means so as to facilitate heat dissipation of the electrodes to reduce the size of a seal extension formed at the end of the elongated seal, and

wherein the resistance element is elastically pre-stretched and then fixed at both ends such that the heat generating means maintains a flat shape when the heat generating means is heated by the heater circuit and expands by heat.

It is preferable that the resistance element is elastically stretched by an amount of ΔE_{R}

wherein ΔE_{R}≧ΔL_{R}

wherein ΔL_{R} indicates a length of extension of the heat generating means by heat expansion.

It is preferable that ΔE_{R} has a range of about 0.2%˜about 3% of the entire length of the heat generating means.

It is preferable that the heat generating means is tensioned by a spring property of the heat generating means.

It is preferable that the resistance element is bent at both ends thereof and wherein a bent head portion is fixed to a side of the press mechanism.

It is preferable that the resistance element is bent by about 90 degrees.

It is preferable that the resistance element includes a notch in a longitudinal side thereof to facilitate bending the resistance element.

It is preferable that the resistance element includes two notches opposite to each other at end of the resistance element.

It is preferable that the slit has a width equal to or less than about 0.3 mm.

According to another aspect of a preferred embodiment of the present invention, the impulse heat sealer further comprises
e. a protective heat-resistant layer detachably adhering on the heat generating means.

It is preferable that the protective heat-resistant layer includes an adhesive layer, the adhesive layer adhering to top of the heat generating means.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a plan view showing conventional structure of a heater element;

FIG. 2 is a side view showing a conventional structure of an impulse heat sealer;

FIG. 3 is an end view showing a conventional structure of a protective tape adhered on a heater element;

FIG. 4 is an end view showing a conventional method of fastening a protective tape on a heater element;

FIG. 5 is a plan view showing a part of a heat sealer according to one embodiment of the present invention;

FIG. 6 is a side view showing a part of a heat sealer according to one embodiment of the present invention;

FIG. 7 is a schematic view showing a resistance element 1 according to one embodiment of the present invention and two overlapping plastic sheets 80 placed and sealed thereon;

FIG. 8 is an enlarged view of a part of heat generating portion 23;

FIG. 9 is an enlarged view of a boundary portion between heat generating portion 23 and electrode 4;

FIG. 10 is a side view showing a method of fastening resistance element 1 to installation base 30;

FIG. 11 is a plan view showing resistance element 1 fastened to installation base 30;

FIG. 12 is a plan view showing structure of resistance element 1;

FIG. 13 is a plan view showing structure of resistance element 1;

FIG. 14 is a side view showing resistance element 1 and installation base 30 shown in FIG. 11;

FIG. 15 is a schematic view showing a resistance element and resulting seal according to another embodiment of the present invention.

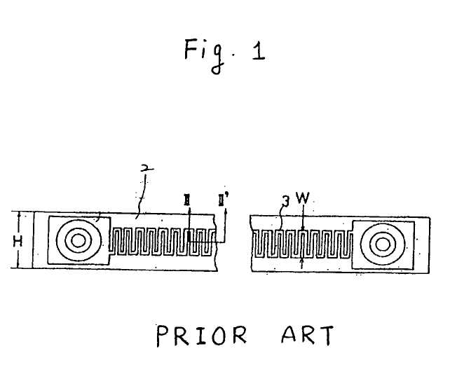

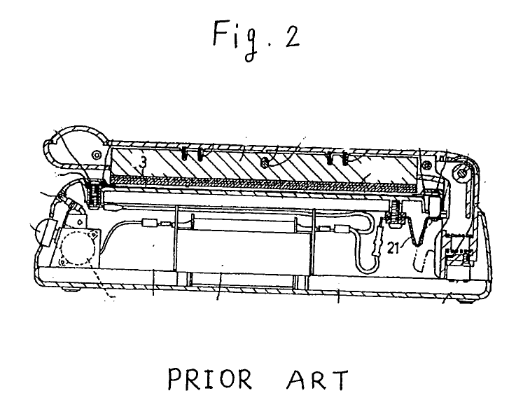

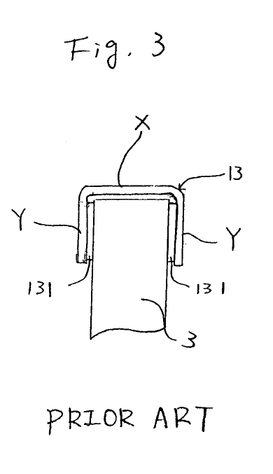

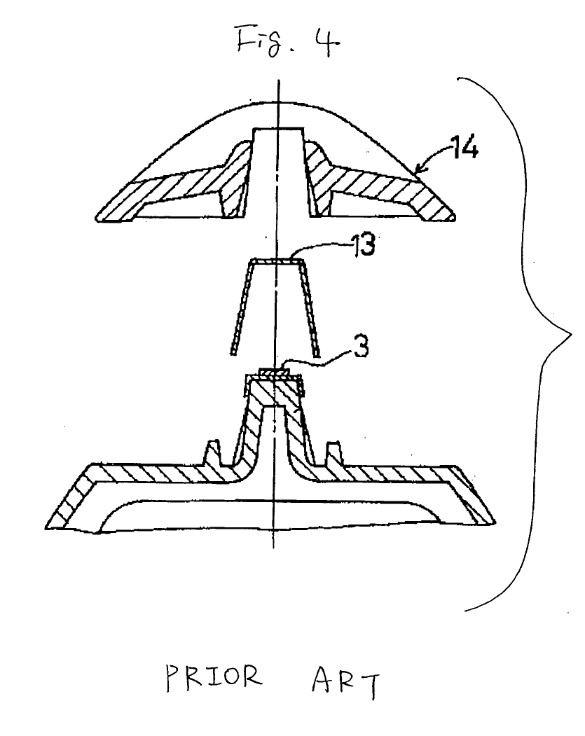

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those having ordinary skill in the art based on these illustrated embodiments.

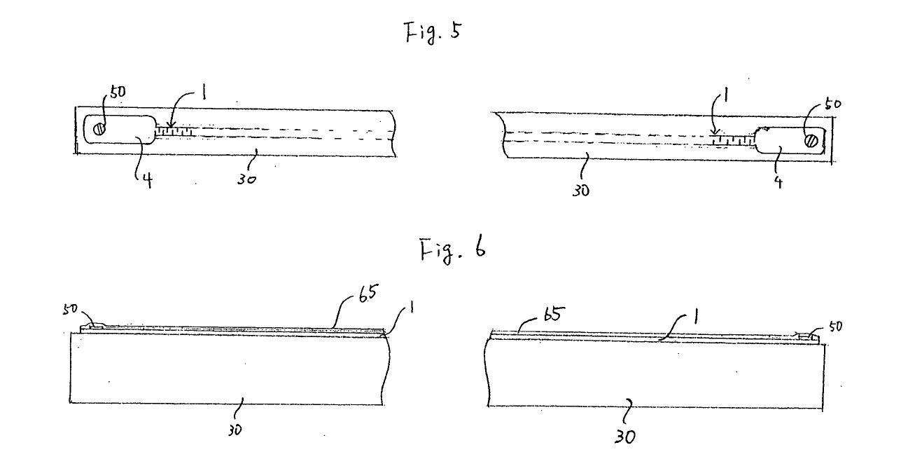

FIG. 5 is a plan view showing a part of a heat sealer according to one embodiment of the present invention. There is provided lower clip 30 composing a press mechanism which clamps sheet-like material. The lower clip 30 also composes an installation base for resistance element 1. As described below, the resistance element 1 has a zigzag shape and is not bonded to the installation base 30. Rather it is pre-stretched in a longitudinal direction, placed on the top surface of the installation base 30 and fixed at both ends to the installation base 30 by using screws 50, 50. Electrodes 4, 4 are connected to heater circuit (not shown) to apply voltage.

As the installation base 30, an upper clip of the press mechanism may be used instead of the lower clip. In this case, the resistance element 1 is attached on the bottom surface of the upper clip.

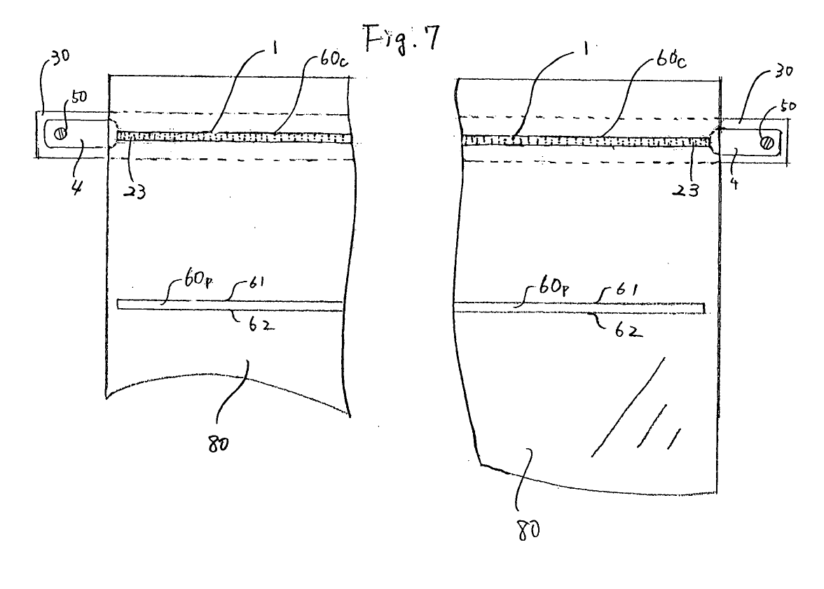

FIG. 6 is a side view of heat sealer shown in FIG. 5. As shown in FIG. 6, the resistance element 1 is fixed on the installation base 30. On the resistance element 1 is provided heat-resistant protective tape 65. Since the resistance element 1 melts and seals sheet-like material such as plastic bags, to prevent the resistance element 1 from being caked with the melted sheet-like material, the protective tape 65 is intervened between the resistance element 1 and the sheet-like material. The protective tape 65 is, for example, a fluoro resin coated glass tape. The protective tape 65 is provided with an adhesive layer on one surface. By this adhesive layer, the protective tape 65 is adhered to the top surface of the resistance element 1. The protective tape 65 may be configured to be peeled off from the surface of the resistance element 1. This configuration is preferable since replacement of the protective tape is made easy.

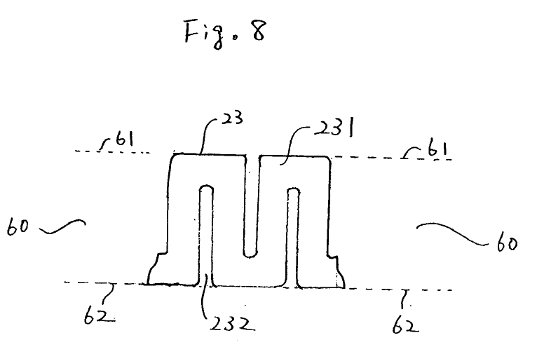

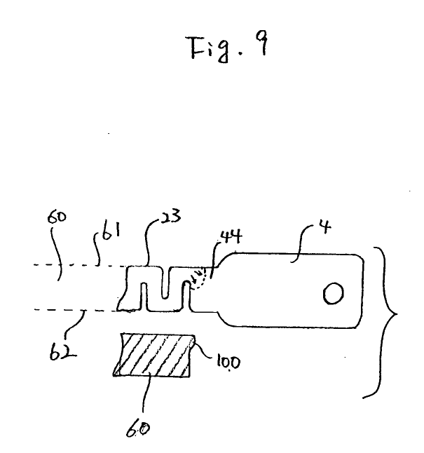

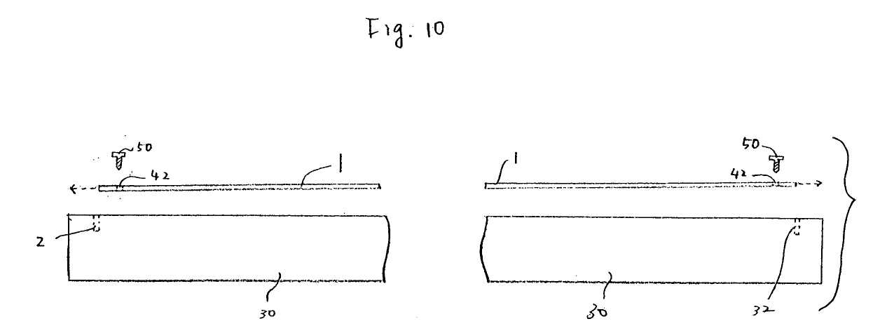

FIG. 7 shows a resistance element 1 according to one embodiment of the present invention and two overlapping plastic sheets 80 placed and sealed on the resistance element 1. In this drawing, there is seal 60ₚ that is previously produced and seal 6_{C} that is currently being produced. The resistance element 1 is composed of a thin plate of high resistance metallic material such as iron chromium material, chromium-iron alloy, stainless steel and stainless alloy. The resistance element 1 includes heat generating portion 23 and electrodes 4, 4 positioned at both ends of the heat generating portion 23 as shown in FIGS. 8 and 9. Both the heat generating portion 23 and the electrodes 4, 4 may be made from one metallic plate. The resistance element 1 may be produced by welding electrodes 4, 4 to both ends of the heat generating portion 23. In this specification, heat generating portion 23 corresponds to heat generating means.

The heat generating portion 23 has an elongated shape in whole. Thus, as shown in FIG. 7, when the plastic sheets 80 are heat-sealed by using the resistance element 1, there is produced a seal 60 having a shape corresponding to the length and width of the elongated shape of the heat generating portion 23, particularly at the place which is pressed and heated by the heat generating portion 23 in the sheets 80.

FIG. 8 is an enlarged view of a part of heat generating portion 23. The heat generating portion 23 has, for example, a width of about 2 mm. The heat generating portion 23 has a zigzag shape composed of a plurality of serpentine portions 231 and a plurality of slits 232. For example, it is preferable that the serpentine portion 231 has a width of about 0.4 mm and the slit 232 a width of about 0.2 mm.

To improve the strength of the seal 60, it is desired to configure the outline of the seal 60 such that upper and lower longitudinal sides 61 and 62 are straight, right and left ends of the seal 60 have no protrusion, and there is no gap inside the seal 60 by uniform sealing. On the other hand, when the sheets 80 are sealed by flowing current to the resistance element 1, as shown in FIG. 7, on the sheets 80 is produced seal 60 having a shape corresponding to the shape of the heat generating portion 23. Thus, if the heat generating portion 23 has a zigzag shape, the zigzag shape as is may be reflected to the shape of the seal 60, such that uneven outline is caused in the upper and lower longitudinal sides of the seal 60 or the slits cause unsealed portions or gaps inside the seal 60. Considering the seal strength, it is desirable to prevent such unevenness and gaps.

In this embodiment, as shown in FIG. 8, the width of the slit 232 is made so narrow that the heat diffused from the adjacent serpentine portions 231 to the slit 232 may heat the space in the slit 232. According to this configuration, it is made possible to heat the sheet material 80 enough at the place to be pressed by the heat generating portion 23, particularly the place corresponding to the slits 232, so as to produce a uniform seal 60 having smooth and straight longitudinal sides 61 and 62.

As an example of the narrow width of the slits, the width of the slits may be less than or equal to about 0.3 mm. Preferably, the width of the slits may be less than or equal to about 0.2 mm. For example, the combination of the serpentine portion 231 having a width of about 0.4 mm and the slit 232 having a width of about 0.2 mm makes it possible to produce a seal 60 having no inside gaps and no uneven longitudinal sides, with a condition that it needs to reach about 80° C. to about 300° C. of usable temperature within four seconds of applying current. The heat generating portion 23 starts to cool right after stopping current flow, and then rapidly cools down without a forced cooling system.

The reason why the gaps disappear from the seal line when the resistance element contains the gaps, is that the heat generated is transferred toward the gaps via the covering fluoro resin coated glass tape, and also by the polyethylene film itself, as it is sealed. Therefore, if the usual thickness of 0.1-0.2 mm is further thickened, or the generated thermal amount and the generating time are increased, the gaps on the seal line will disappear even if the gap is more than 0.2 mm. Further, a gap of less than 0.1 mm is, of course, preferable, however, mass production using etching will become difficult. Within the defined range, a gap having a taper is acceptable.

Next, FIG. 9 is an enlarged view of a boundary portion between heat generating portion 23 and electrode 4. As shown in FIG. 9, in a boundary portion between heat generating portion 23 and electrode 4, the heat is conducted from the heat generating portion 23 to the electrode 4 as indicated by arrows. This heat flow heats an adjacent region 44 of the electrode 4 which is adjacent to the heat generating portion 23. This heated adjacent region 44 is contacted and pressed to the sheets 80 to produce seal extension portion 100 at the end of the seal 60.

Since the seal extension portion 100 protrudes from the seal 60, it causes stress concentration to reduce the strength of the seal 60. Thus, it is desirable to produce the smallest possible seal extension portion 100, if any, and make the seal extension portion 100 extend toward the center of the seal 60.

In this embodiment, the electrodes 4, 4 and the adjacent region 44 have a width two times or more of the width of about 0.4 mm of the heat generating portion 23. According to this configuration, the heat dissipation is facilitated in the adjacent region 44 or the electrode 4 to suppress overheating of the adjacent region 44 to reduce the size of the seal extension portion 100.

The resistance element 1 includes a heat generating portion 23 and electrode 4 which are formed from a same plate member by photo etching. In this process, a thin plate is formed by rolling an iron chromium material into 0.1 mm thickness, and then is adjusted into a proper hardness. By use of a photosensitive material coated in advance, after photo-masking a pattern, and after the coated photosensitive material is exposed and fixed, a further covering film may be applied, with dissolving and removing unnecessary portions by acid to complete the patterned product. Further, as processing methods thereof, wire cutting and laser cutting can be used.

With an annealed material such as iron chromium material and nichrome alloy, a resistance element having width of even 2 mm is soft and deforms during treatment thereof, if the thickness thereof is not about 0.2 mm. Since today, a thin plate having thickness of 0.1 mm can be manufactured by economical rolling, and the thin plate can be strengthened through a proper degree of quenching, a heat generating portion having a zigzag in the interval of 0.4 mm as referred to above demonstrates a sufficiently practical strength. However, if the tempering is too strong, the zigzaged heat generating portion is likely to break, therefore, the quenching amount has to be proper.

The resistance value of the zigzag shaped resistance element is about 25Ω when fine slits of about 0.2 mm are cut on the heat generating portion 23, with intervals of about 0.4 mm in a zigzag manner. In contrast, an electrical resistance of a resistance element having the width of 2 mm and length of 200 mm, forms the same seal line as above with 2Ω. Therefore, in the electrical point of view, the latter conventional resistance element requires about 16V and 8 A, while the resistance element of the present invention forms the same seal line, as the conventional one, requiring a high voltage of 50V and a low current of 2 A.

If the commercial source voltage is 100V, it can be applied by subjecting the same to half-wave rectification, or further if the length of the resistance element is elongated by 1.4 times to 280 mm, the commercial source voltage of 100V can be directly applied to the resistance element. Still further, if the commercial source voltage is 200V, when the length of the resistance element is elongated by a factor of two, the commercial source voltage can be applied to the resistance element after subjecting the same to half-wave rectification. When the width of the resistance element is modified to 3 mm, and the length thereof is elongated in total to three times, the commercial source voltage of 200V can be applied as it is, obviating the need for a transformer and a voltage regulating circuit.

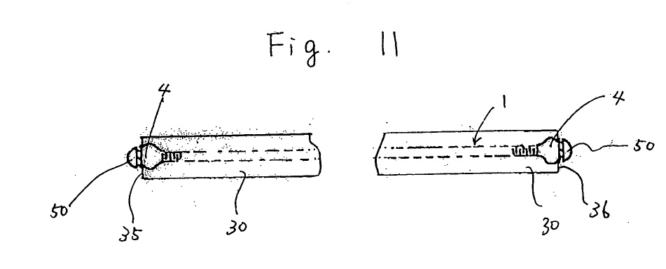

FIG. 10 shows a method of fastening the resistance element 1 to the installation base 30. As shown in FIG. 10, the resistance element 1 is fixed on the top surface of the installation base 30 by stretching the resistance element 1 in a longitudinal direction, aligning through holes 42, 42 of the resistance element 1 with installation openings 32, 32 of the installation base 30 and fastening the resistance element 1 to the installation base 30 by screws 50, 50. Then, protective tape 65 (not shown) is adhered on the pre-stretched and fixed resistance element 1.

To absorb the extension of the heat generating portion 23 caused by heat expansion, the zigzag structure of the heat generating portion 23 needs to have a spring property. In addition, it is needed that the zigzag structure is elastically deformed when the resistance element 1 is stretched in the longitudinal direction. As an example of material with such features, it is preferable to use stainless steel having a hardness of about 200-about 500 Hv (Vickers hardness) for the heat generating portion 23.

The resistance element 1 is pre-stretched by an amount of ΔE_{R} . Provided that the resistance element 1 extends in longitudinal direction by an amount of ΔL_{R} due to thermal expansion, the following formula should be satisfied:
ΔE_{R}≧ΔL_{R}

For example, it is preferable to pre-stretch the resistance element 1 by about 0.2% to about 3% of the total length of the resistance element 1. Specifically, the distance between the installation openings 32 and 32 is configured to be about 0.2% to about 3% larger than the distance between the through holes 42 and 42.

By pre-stretching the resistance element 1, the resistance element 1 is fixed to the installation base 30 while being tensioned highly. When such resistance element 1 is heated and thermally expands, while each unit of the serpentine portions 231 is slightly deformed in the light of microscopic scale of the unit of serpentine portion, the shape of the resistance element 1 is hardly deformed in the light of macroscopic scale of the entire resistance element 1. Particularly, the total length of the resistance element 1 is not varied since the extension of the resistance element 1 in longitudinal direction is absorbed by the stretched configuration.

According to this configuration, the extension of the heat generating portion 23 in the longitudinal direction may be fully absorbed when it is heated, since the zigzag portion of the heat generating portion 23 is pre-stretched by more than the length of the extension of the heat generating portion 23 caused by thermal expansion and the resistance element 1 is fixed at both ends. Accordingly, even if the resistance element 1 is thermally expanded, the total length of the resistance element 1 is not varied to prevent the protective tape 65 from peeling off or creasing. Also, even if the resistance element 1 is thermally expanded, the shape of the resistance element 1 may be kept flat and straight to continuously produce a seal having the desired form.

Furthermore, since the spring-like resistance element 1 is fixed while being tensioned, it may be kept in a stable straight shape even if some external force is applied to the resistance element 1. Thus, the process of adhering the protective tape 65 on the resistance element 1 is made easier.

On the other hand, if the resistance element 1 is stretched, the width of each of slits 232 is made wider like a coil spring. Thus, the space in the slit is extended to increase the amount of heat required to heat the space enough. However, if the amount of stretch falls within about 0.2% to about 3.0% in the total length, the extension in a slit unit is so small as to cause minimum effect, if any.

Specifically, for example, if the heat generating portion 23 has a total length of 200 mm, the serpentine portion 231 has a width of 0.4 mm and the slit 232 has a width of 0.2 mm, the total number N of slits included in the heat generating portion 23 is calculated as:
N=200/0.6=333.3

If the heat generating portion 23 is stretched by 0.5%, the total stretch of the heat generating portion 23 is calculated as:
ΔE_{R}=200×0.005=1.0 mm

The amount of the extension αW in the width of each slit is calculated as:
ΔW =1.0/333.3=0.003 mm

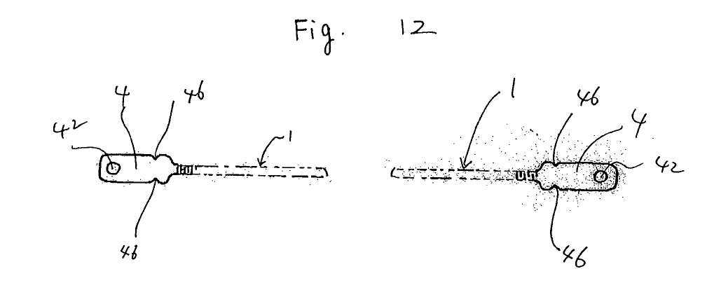

FIGS. 11-14 shows another method of fastening the resistance element 1 to the installation base 30. In these drawings, the like numeral references indicate like elements and duplicative explanation will be omitted. FIG. 11 is a plan view showing the resistance element 1 fastened to the installation base 30. In this embodiment, the resistance element 1, particularly both electrodes 4, 4 are bent at both ends 35, 36 of the installation base 30 and fixed at the both ends 35, 36 of the installation base 30.

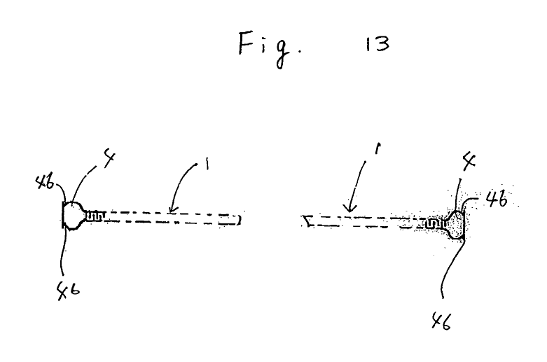

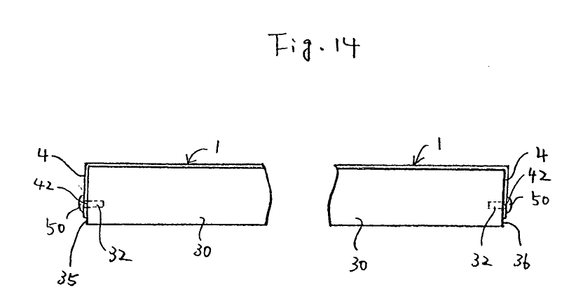

FIGS. 12 and 13 are plan views showing structure of the resistance element 1. The electrode 4 has, in both longitudinal sides, notches 46, 46 to facilitate bending process. These notches 46, 46 are opposite to each other and perpendicular to the longitudinal axis of the resistance element 1. By bending the electrode 4 along the opposing notches 46, 46, the bent state is obtained as shown in FIG. 13.

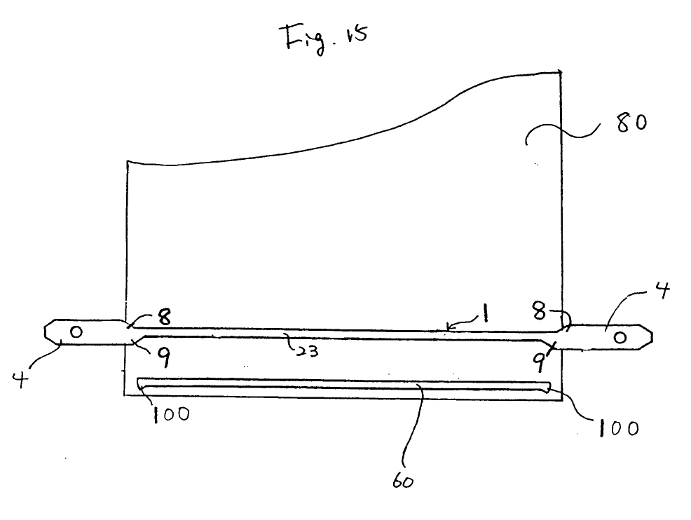

FIG. 14 is a side view showing the resistance element 1 and the installation base 30 shown in FIG. 11. As shown in FIG. 14, the resistance element 1 in the bent state is stretched, the through holes 42, 42 at both ends of the resistance element 1 are aligned with installation openings 32, 32 provided in both end surfaces of the installation base 30 and the bent head portions of the resistance element 1 are fixed to the both end surfaces of the installation base 30 respectively by using screws 50, 50. On the pre-stretched and fixed resistance element 1, the protective tape 65 (not shown) is adhered.

As the amount of pre-stretch of the resistance element 1, the distance between the installation openings 32 and 32 is configured to be about 0.2% to about 3% larger than the distance between the through holes 42 and 42 in bent state. This configuration may be explained as the ratio of the length of the installation base 30 to the distance between the notch 46 in one electrode 4 positioned at one end of the resistance element 1 and another notch 46 in the other electrode 4 positioned at the other end of the resistance element 1. It is preferable to bend the resistance element 1 by about ninety degrees.

According to this embodiment, by bending the end of the resistance element 1 and fixing the bent resistance element 1 to the installation base 30, it is facilitated to make the length of the installation base 30 smaller to reduce the total length of the apparatus.

FIG. 15 is a schematic view showing a resistance element and resulting seal according to another embodiment of the present invention. To prevent swelling of the seal line at the main body side of the bag 80, by offsetting the heat generating portion 23 from the center and by eliminating a width broadened portion 8 at the side of the bag main body, the width at the opposite side is doubled. Also, as shown in FIG. 15, the width broadened portion 8 at the side of the bag main body is provided closer to the end of the resistance element 1, in comparison with the width broadened portion 9 located at the opposite side which is the side of the bag edges. In this instance, although the swelling 100 on the seal line is formed, it only appears at the side of the bag edges. Thus the swellings are aligned at one side where the negative influence is small.

Further, the sealer pressing mechanism of the present invention includes a pressing operation in which a worker grips a T shaped hand type handle being provided with a heater at one side thereof by the hand, and performs heat sealing by pressing the same on polyethylene placed on a work stand. Further, since the present heater can be operated while omitting the voltage regulator, the power source circuit can be a simple current supply from the power source to the heater. Further, since the impulse sealer of the present invention is lightweight and can be directly coupled to a power source, the present impulse sealer can be actively used in a field where only heating plate type heaters are conventionally used.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as a non-specific, general reference and may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An impulse heat sealer to seal at least two overlapped sheets, comprising:
a. a power source;
b. a heater circuit connected to the power source;
c. a press mechanism to press the overlapped sheets; and
d. a resistance element attached to the heater circuit and the press mechanism, the resistance element comprising:
i. a heat generating means made of electrically high resistance material to generate heat to seal the overlapped sheets, the heat generating means having an elongated shape and being arranged to produce an elongated seal, the heat generating means having a zigzag portion formed with a plurality of serpentine portions and slits, the slits having a width to prevent a gap corresponding to the slits being formed in the elongated seal by a heat diffusion from the adjacent serpentine portions so that the elongated seal has substantially straight longitudinal sides,
ii. a pair of electrodes attached at both ends of the heat generating means, each electrode having a width more than twice as large as that of the heat generating means so as to facilitate heat dissipation of the electrodes to reduce the size of a seal extension formed at the end of the elongated seal, and
wherein the resistance element is elastically pre-stretched and then fixed at both ends such that the heat generating means maintains a flat shape when the heat generating means is heated by the heater circuit and expands by heat.

2. The impulse heat sealer according to claim 1, wherein the resistance element is elastically stretched by an amount of ΔE_{R} ,
wherein ΔE_{R}≧ΔL_{R}, and wherein ΔL_{R} indicates a length of extension of the heat generating means by heat expansion.

3. The impulse heat sealer according to claim 2, wherein ΔE_{R} has a range of about 0.2%˜about 3% of the entire length of the heat generating means.

4. The impulse heat sealer according to claim 1, wherein the heat generating means is tensioned by a spring property of the heat generating means.

5. The impulse heat sealer according to claim 1, wherein the resistance element is bent at both ends thereof and wherein a bent head portion is fixed to a side of the press mechanism.

6. The impulse heat sealer according to claim 5, wherein the resistance element is bent by about 90 degrees.

7. The impulse heat sealer according to claim 5, wherein the resistance element includes a notch in a longitudinal side thereof to facilitate bending the resistance element.

8. The impulse heat sealer according to claim 7, wherein the resistance element includes two notches opposite to each other at end of the resistance element.

9. The impulse heat sealer according to claim 1, wherein the slit has a width equal to or less than about 0.3 mm.

10. The impulse heat sealer according to claim 1 further comprising
e. a protective heat-resistant layer detachably adhering on the heat generating means.

11. The impulse heat sealer according to claim 10, wherein the protective heat-resistant layer includes an adhesive layer, the adhesive layer adhering to top of the heat generating means.
